(19) United States
(12) Patent Application Publication
(10) Pub. No.: US 2013/0202511 A1
(43) Pub. Date: Aug. 8, 2013

(54) Method for Removal of Heterocyclic Sulfur using Metallic Copper

(71) Applicants: Vladislav I. Kanazirev, Arlington Heights, IL (US); Jayant K. Gorawara, Buffalo Grove, IL (US)

(72) Inventors: Vladislav I. Kanazirev, Arlington Heights, IL (US); Jayant K. Gorawara, Buffalo Grove, IL (US)

(73) Assignee: UOP LLC, Des Plaines, IL (US)

(21) Appl. No.: 13/367,174

(22) Filed: Feb. 6, 2012

(51) Int. Cl. B01D 53/48; B01D 15/00; B01D 53/52

(52) U.S. Cl. 423/230; 423/244.06; 423/244.02; 210/660

(57) ABSTRACT

A method of removing mercaptans, heterocyclic sulfur compounds, and/or COS from a fluid stream comprising contacting the fluid stream with a sorbent comprising a mixture of Cu₂O and metallic copper.

### FIELD OF THE INVENTION

The disclosure relates in general to the removal of contaminants from hydrocarbon liquids and gases. In certain embodiments, the disclosure relates to the use of a copper-based sorbent to remove sulfur compounds from hydrocarbon streams. In certain embodiments, the disclosure relates to the use of a sorbent comprising supported cuprous oxide and metallic copper to remove heterocyclic sulfides and other sulfur compounds from hydrocarbon streams.

### BACKGROUND OF THE INVENTION

The removal of sulfur compounds from gas and liquid streams is an important application in the hydrocarbon industry. Hydrogen sulfide (H₂S), a common sulfur-based contaminate, can be removed by supported cupric oxide adsorbents known in the prior art. Other sulfur-containing contaminates, however, are more difficult to remove. For example, heterocyclic sulfides, such as thiophene, co-boil with many desirable hydrocarbons, such as benzene, and thus cannot be separated by distillation. In addition, prior art cupric oxide adsorbents are not effective in removing heterocyclic sulfides. Moreover, cupric oxide adsorbents react with mercaptans to produce disulfides by reaction (1). The disulfide impurities remain in the hydrocarbon stream.

2CuO+2RSH→RS—SR+H₂O+Cu₂O (1)

As such, the use of cupric oxide sorbents in hydrocarbon streams containing both hydrogen sulfide in combination with heterocyclic sulfides and/or mercaptans will not achieve full sulfur removal.

Zeolites, alumina (Al₂O₃), and supported metal oxides are known in the prior art to remove heterocyclic sulfides by adsorption, where the sulfides are selectively trapped in the porous structure of the adsorbent. However, as a result of the acidity of the solid adsorbent, discoloration of the product stream can occur at high application temperatures. In addition, the physical adsorbents are not effective in removing hydrogen sulfide. Therefore, full sulfur removal would require multiple steps for hydrocarbon streams containing hydrogen sulfide and heterocyclic sulfides.

Accordingly, it would be an advance in the state of the art to provide a copper-based material, and method of using same, for complete sulfur removal of hydrocarbon streams containing both heterocyclic sulfur compounds and hydrogen sulfides.

### SUMMARY OF THE INVENTION

A method of removing at least one impurity selected from the group consisting of H₂S, a mercaptan, a heterocyclic sulfur compound, and COS from a fluid stream. The method comprises contacting the stream with a sorbent comprising a mixture of cuprous oxide and metallic copper.

### DETAILED DESCRIPTION OF PREFERRED EMBODIMENTS

The invention is described in preferred embodiments in the following description. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The terms sorbent, adsorbent, and absorbent as used herein refer to the ability of a material to take in or soak up liquid or gas components on the surface thereof or to assimilate such components into the body thereof, whether by chemisorption (i.e., scavenging) or filtering (by way of a molecular sieve).

Applicants' sorbent comprises metallic copper in combination with cuprous oxide disposed within a support material. The metallic copper is capable of reacting with the sulfur atom on the heterocyclic sulfide, such as thiophene (1), at elevated temperatures.

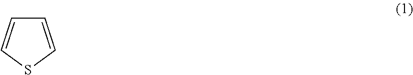

Applicants' sorbent comprises both metallic copper (Cu) and cuprous oxide (Cu₂O). In one embodiment, the sorbent comprises no or substantially no cupric oxide (CuO). Metallic copper is effective in scavenging heterocyclic sulfides. The cuprous oxide is effective in scavenging other sulfur compounds, such as hydrogen sulfide and/or mercaptans, without the undesired production of disulfide compounds. In addition, the use of cuprous oxide rather than cupric oxide avoids the release of large amounts of water, detrimental to downstream processes, generated by the reduction of cupric oxide by hydrocarbons at elevated temperatures by reactions (2) and (3). As such, embodiments of Applicants' sorbent without cupric sulfide result in no disulfide compound formation.

2CuO+H₂→Cu₂O+H₂O (2)

2CuO+Alkane→Cu₂O+H₂O+Alkene (3)

In various embodiments, the support material is a metal oxide selected from the group consisting of alumina, silica, silica-aluminas, silicates, aluminates, crystalline-aluminas such as zeolites, titania, zirconia, hematite, ceria, magnesium oxide, and tungsten oxide. In one embodiment, the support material is alumina. In some embodiments, the support material is carbon or activated carbon. In certain embodiments, Applicants' sorbent does not comprise a binder.

In various embodiments, the alumina support material is present in the form of transition alumina, which comprises a mixture of poorly crystalline alumina phases such as “rho,” “chi” and “pseudo gamma” aluminas which are capable of quick rehydration and can retain substantial amounts of water in a reactive form. An aluminum hydroxide Al(OH)₃, such as Gibbsite, is a source for preparation of transition alumina. The prior art industrial process for production of transition alumina includes milling Gibbsite to 1-20 microns particle size followed by flash calcination for a short contact time as described in the patent literature such as in U.S. Pat. No. 2,915,365. Amorphous aluminum hydroxide and other naturally found mineral crystalline hydroxides e.g., Bayerite and Nordstrandite or monoxide hydroxides, AlOOH, such as Boehmite and Diaspore can be also used as a source of transition alumina. In certain embodiments, the BET surface area of this transition alumina material is about 300 m²/g and the average pore diameter is about 45 angstroms as determined by nitrogen adsorption, resulting in a porous sorbent.

In various embodiments, a solid oxysalt of a transition metal is used as a starting component of the sorbent. “Oxysalt,” by definition, refers to any salt of an oxyacid. Sometimes this definition is broadened to “a salt containing oxygen as well as a given anion.” FeOCl, for example, is regarded as an oxysalt according this definition.

In certain embodiments, the oxysalt comprises one or more copper carbonates. Basic copper carbonates, such as Cu₂CO₃(OH)₂, can be produced by precipitation of copper salts, such as Cu(NO)₃, CuSO₄ and CuCl₂, with sodium carbonate. In one embodiment, a synthetic form of malachite, a basic copper carbonate, produced by Phibro Tech, Ridgefield Park, N.J., is used as a component of the sorbent.

Depending on the conditions used, and especially on washing the resulting precipitate, the final material may contain some residual product from the precipitation process. In the case of the CuCl₂ raw material, sodium chloride is a side product of the precipitation process. It has been determined that a commercially available basic copper carbonate that had both residual chloride and sodium, exhibited lower stability towards heating and improved resistance towards reduction than other commercial basic copper carbonates that were practically chloride-free.

In one embodiment, the particle size of the basic copper carbonate particles is approximately in the range of that of the transition alumina, namely 1-20 microns. In other embodiments, the sorbent comprises the oxysalt Azurite, Cu₃(CO₃)₂(OH)₂. In other embodiments, the sorbent comprises an oxysalt of copper, nickel, iron, manganese, cobalt, zinc or a mixture thereof.

In certain embodiments, the sorbent is produced by calcinating a mixture of an inorganic halide additive and basic copper carbonate for a sufficient period of time to decompose the basic copper carbonate into an oxide. In various embodiments, the inorganic halides are sodium chloride, potassium chloride or mixtures thereof. In certain embodiments, the inorganic halides are bromide salts. In various embodiments, the chloride content in the sorbent ranges from 0.05 mass percent to 2.5 mass percent. In various embodiments, the chloride content in the sorbent ranges from 0.3 mass percent to 1.2 mass percent. The copper oxide-based sorbent that contains the halide salt exhibits a higher resistance to reduction than does a similar sorbent that is made without the halide salt. In certain embodiments, Applicants' sorbent comprises chloride anions.

In one embodiment, the sorbent is produced by conodulizing basic copper carbonate with alumina followed by curing and activation. In various embodiments, the nodulizing, or agglomeration, is performed in a pan or a drum. The materials are agitated by the oscillating or rotating motion of the nodulizer while spraying with water to form beads. In one embodiment, the beads are cured at about 60° C. and dried in a moving bed activator at a temperature at or below about 175° C. In other embodiments, the sorbent beads are formed by extrusion.

In certain embodiments, the copper carbonate is decomposed to an oxide by calcinating the sorbent beads at between about 250° C. to about 450° C. In one embodiment, the copper carbonate is decomposed to an oxide by calcinating the sorbent beads in an atmosphere of an inert gas at about 320° C. The heat reduces the copper in the copper carbonate to produce cupric oxide (CuO).

In various embodiments, and depending on the application, the sorbent comprises about 5 mass percent to about 85 mass percent copper, calculated as CuO on a volatile-free basis. In various embodiments, the sorbent comprises about 20 mass percent to about 70 mass percent copper, calculated as CuO on a volatile-free basis. In various embodiments, the sorbent comprises about 30 mass percent to about 60 mass percent copper, calculated as CuO on a volatile-free basis. In one embodiment, the sorbent comprises about 32 mass percent to about 34 mass percent copper, calculated as CuO on a volatile-free basis. In one embodiment, the sorbent comprises about 38 mass percent copper, calculated as CuO on a volatile-free basis. In one embodiment, the sorbent comprises about 40 mass percent copper, calculated as CuO on a volatile-free basis. In one embodiment, the sorbent comprises about 70 mass percent copper, calculated as CuO on a volatile-free basis.

In certain embodiments, the sorbent has a diameter (for spherical beads) or maximum width (for irregular shaped beads) of about 1 mm to about 10 mm. In certain embodiments, the sorbent has a diameter or maximum width of about 1.5 mm to about 3 mm.

The cupric oxide-containing sorbent is activated by exposure to a reducing environment to form metallic copper. In various embodiments, the reducing environment comprises hydrogen gas (H₂), carbon monoxide gas (CO), methane (CH₄), or a combination thereof. In various embodiments, the reduction occurs at a temperature below about 190° C., depending on the reducing agent and the exposure time. In various embodiments, the reduction occurs at a temperature below about 250° C. In various embodiments, the reduction occurs at between about 100° C. to about 200° C. In various embodiments, the reduction occurs at between about 120° C. to about 190° C. In various embodiments, the reduction occurs at between about 120° C. to about 190° C. with a hydrocarbon reducing agent. In certain embodiments, the conversion of CuO to metallic copper is complete, leaving no CuO in the final sorbent or substantially no CuO in the final sorbent.

In various embodiments, and depending on the application, the sorbent comprises about 5 mass percent copper to about 95 mass percent copper, calculated as CuO on a volatile free basis. In one embodiment, the sorbent comprises about 32 mass percent copper calculated as CuO on a volatile-free basis. In one embodiment, the sorbent comprises about 68 mass percent copper calculated as CuO on a volatile-free basis.

In another embodiment, after decomposition, the sorbent comprising a halide salt is activated by exposure to a reducing environment to form copper at a plurality of oxidation levels. In various embodiments, the reducing environment comprises a reduction agent, such as without limitation, H₂, CO, CH₄, or a combination thereof. The halide salt inhibits reduction of copper. As such, the reduction from an oxidation level of +2 (CuO), to an oxidation level of +1 (Cu₂O), to an oxidation level of +0 (metallic copper), is controlled and selectively determined oxidation profile is achieved. In various embodiments, Applicants' sorbent comprises metallic copper (+0 oxidation level), cuprous oxide (Cu₂O, +1 oxidation level), or a combination thereof. In various embodiments, Applicants' sorbent comprises metallic copper (+0 oxidation level), cupric oxide (CuO, +2 oxidation level), cuprous oxide (Cu₂O, +1 oxidation level), or a combination thereof. The amount of halide salt in the sorbent is selected based on the desired distribution of copper oxidation states in the final sorbent.

In one embodiment, the percentage of metallic copper relative to the total amount of copper in the sorbent, calculated as CuO on a volatile free basis, is between about 5 mass percent to about 50 mass percent. In one embodiment, the ratio of Cu/Cu₂O is ¼. In one embodiment, the ratio of Cu/CuO/Cu₂O is 8/2/45.

The metallic copper-containing sorbent beads are placed in a flowing hydrocarbon stream at a temperature of about 150° C. to about 200° C. to remove heterocyclic compounds comprising sulfur, such as without limitation thiophene, and other sulfur compounds, including without limitation hydrogen sulfide and/or mercaptans, without the production of disulfide compounds.

The following Example is presented to further illustrate to persons skilled in the art how to make and use the invention. This Example is not intended as a limitation, however, upon the scope of Applicant's invention.

### EXAMPLE

A mixture of a copper oxysalt and a support material is provided. In one embodiment, the copper oxysalt is basic copper carbonate, Cu₂(OH)₂CO₃ and the support material is alumina powder capable of rehydration. In different embodiments, the copper content of the mixture, calculated as CuO on a volatile free basis, is between about 5 mass percent and about 95 mass percent.

Green sorbent beads are formed from the mixture. As used herein, “green sorbent beads” refer to beads containing the copper oxysalt before reduction and “activated sorbent beads” refer to beads where at least a portion of the copper oxysalt has been decomposed to cuprous oxide and metallic copper. In one embodiment, the beads are formed by nodulizing the mixture in a rotating pan nodulizer while spraying with a liquid. In one embodiment, the liquid comprises water. In one embodiment, the liquid comprises a solution of water and a halide salt. In one embodiment, the halide salt is sodium chloride. The amount of sodium chloride in solution is selected based on the desired ratio of the various active copper components in the final product. In one embodiment, the solution comprises between about 1 mass percent and about 3 mass percent solution of sodium chloride.

In another embodiment, the green sorbent beads are formed by agglomeration. In another embodiment, the green sorbent beads are formed by extrusion. Those skilled in the art will appreciate that other methods may be performed to produce regular- or irregular-shaped beads that fall within the scope of Applicants' invention.

The green sorbent beads are cured and dried. In one embodiment, the curing occurs at about 60° C. In one embodiment, the beads are dried in a moving bed activator at temperatures at or below 175° C. In one embodiment, the activated sorbent beads comprise about 0.5 mass percent to about 0.8 mass percent chloride.

The copper in the sorbent beads is decomposed to CuO. In one embodiment, the decomposition occurs in an inert gas atmosphere. In one embodiment, the decomposition occurs at about 320° C. In certain embodiments, the decomposition to CuO in the sorbent beads is complete (i.e., all or substantially all copper in the sorbent is decomposed to CuO).

In certain embodiments, the CuO in the sorbent beads is reduced to Cu₂O and Cu by exposure to a reducing environment. In different embodiments, the reducing environment comprises an atmosphere of hydrogen, carbon monoxide, natural gas, methane, or a combination thereof. In various embodiments, the reduction takes place at a temperature of less than about 190° C. In various embodiments, the reduction takes place at a temperature of about 120° C. to about 190° C. In one embodiment, the CuO is reduced with a hydrocarbon at a temperature of less than about 190° C. In certain embodiments, liquid reduction agents, such as without limitation liquid hydrocarbons, are used at temperatures between about 180° C. and about 350° C. In certain embodiments, the reduction to Cu₂O and metallic copper in the sorbent beads is complete (i.e., all or substantially all CuO is reduced to Cu₂O and metallic copper). In certain embodiments, the reduction is monitored by x-ray diffraction or color sensors.

A portion of the Cu₂O is further reduced to metallic copper (Cu). The halide salt inhibits copper reduction; therefore the mix of cuprous oxide and metallic copper can be selectively determined by varying the amount of salt in the green sorbent and the reducing environment condition and duration.

The sorbent is placed in a hydrocarbon fluid (i.e., gas or liquid) stream containing sulfide impurities. In one embodiment, the hydrocarbon stream comprises heterocyclic sulfides, such as thiophene. In one embodiment, the hydrocarbon stream comprises heterocyclic sulfides and hydrogen sulfide. In one embodiment, the temperature of the stream is between about 150° C. to about 200° C.

The described features, structures, or characteristics of the invention may be combined in any suitable manner in one or more embodiments. In the above description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. In other words, the present invention may be embodied in other specific forms without departing from its spirit or essential characteristics. The described implementations are to be considered in all respects only as illustrative and not restrictive. The scope of the invention should, therefore, be determined not with reference to the above description, but instead should be determined with reference to the pending claims along with their full scope or equivalents, and all changes which come within the meaning and range of equivalency of the claims are to be embraced within their full scope.

What is claimed is:

1. A method of removing from a fluid stream at least one impurity selected from the group consisting of H₂S, a mercaptan, a heterocyclic sulfur compound, and COS, comprising contacting said fluid stream with a sorbent comprising a mixture of Cu₂O and metallic copper.

2. The method of claim 1, wherein said sorbent comprises no CuO.

3. The method of claim 1, wherein said sorbent further comprises at least one halide salt.

4. The method of claim 3, wherein said at least one halide salt comprises a chloride and said chloride comprises from about 0.05 to about 2.5 mass percent of said sorbent.

5. The method of claim 3, wherein said at least one halide salt comprises a chloride and said chloride comprises from about 0.3 mass percent to about 1.2 mass percent of said sorbent.

6. The method of claim 1 wherein the mixture of Cu₂O and metallic copper is made by reducing CuO at a temperature between about 100° C. about 200° C.

7. The method of claim 6 wherein the CuO is reduced with a hydrocarbon at a temperature between about 120 ° C. and about 190° C.

8. The method of claim 1, wherein the impurity comprises a mercaptan, the method further comprising forming no disulfide compounds.

9. The method of claim 1, wherein the impurity comprises a heterocyclic compound comprising sulfur, the method further comprising forming no disulfide compounds.

10. The method of claim 1, wherein said sorbet further comprises a support material.

11. The method of claim 10, wherein said support material is porous.

12. The method of claim 11, wherein said support material comprises alumina.

13. The method of claim 1, wherein said sorbet comprises a copper content of between about 5 mass percent and 85 mass percent, calculated as CuO on a volatile-free basis.

14. The method of claim 13, wherein said sorbet comprises a copper content of between about 30 mass percent and 60 mass percent, calculated as CuO on a volatile-free basis.

15. The method of claim 14, wherein the mass ratio of Cu to Cu₂O expressed as percent CuO on a volatile free basis is ¼.

16. The method of claim 1, wherein said sorbent has a diameter (or a maximum width) of between about 1 mm to about 10 mm.

17. The method of claim 16, wherein said sorbent has a diameter (or a maximum width) of between about 1.5 mm to 3 mm.

18. The method of claim 1, wherein the mixture of Cu₂O and metallic copper is formed by reducing CuO with a gaseous reduction agent at temperatures below 250° C.

19. The method of claim 18, wherein the gaseous reduction agent comprises at least one of H₂, CO, CH₄, or a combination thereof.
